(19) United States
(12) Patent Application Publication
(10) Pub. No.: US 2011/0192907 A1
(43) Pub. Date: Aug. 11, 2011

(54) Gem Based Credit Card Identifier

(75) Inventor: Jacob Galili, Tel-Aviv (IL)

(73) Assignee: Diamond Card Ltd., Mahe (SC)

(21) Appl. No.: 12/703,803

(22) Filed: Feb. 11, 2010

(51) Int. Cl. G06K 19/00

(52) U.S. Cl. 235/487

(57) ABSTRACT

A credit card studded with gems to identify the card holder as an individual having top financial privileges provided by the card issuer and/or the institutions honoring the card.

### FIELD AND BACKGROUND OF THE INVENTION

The present invention relates to credit cards and, in particular, it concerns the use of gems interconnected to credit cards as a means of identifying the level of financial privileges possessed by the card holder.

It is known that the credit card entitles its holder to buy goods and services based on the holder's promise to pay for these goods and services. The issuer of the card grants a line of credit to the user or the consumer from which the user can borrow money for payment to a merchant as a cash advance to the user. The line of credit is typically divided into categories based on the user's financial means and demarcated by some distinguishing card feature like card color. The current invention employs a precious stone fastened or embedded in the body of the card to indicate that the card older possesses a premier line of credit or other financial privileges.

### SUMMARY OF THE INVENTION

The present invention is credit card studded with precious stones to identify the card holder as an individual having top financial privileges provided by the card issuer and institutions honoring the card.

According to the teachings of the present invention there is provided a credit card comprising: (a) a card body and (b) at least one gem interconnected to said card body so as to clearly differentiate said card from other credit cards.

According to a further feature of the present invention, the gem is implemented as a precious stone.

According to a further feature of the present invention, the precious stone is partially imbedded in said card body.

According to a further feature of the present invention, the precious stone is implemented as a natural diamond.

According to a further feature of the present invention, the diamond is implemented as a synthetic diamond.

According to a further feature of the present invention, the gem is implemented as an imitation diamond.

According to a further feature of the present invention, the imitation diamond is imbedded in said card body.

According to a further feature of the present invention, the gem is implemented as a semi-precious stone.

According to a further feature of the present invention, the semi-precious stone is partially embedded in said card body.

According to a further feature of the present invention, the gem is implemented as a black diamond.

### BRIEF DESCRIPTION OF THE DRAWINGS

The invention is herein described, by way of example only, with reference to the accompanying drawings, wherein:

FIG. 1 is a schematic, front-view of a credit card having a gem embedded into the card.

FIG. 2 is a schematic, cross-sectional view depicting a gem partially embedded into the credit card body.

FIG. 3 is a schematic, front-view of a credit card having three precious stones embedded into the card body.

FIG. 4 is a schematic, back-view of the credit card of FIGS. 1-3.

### DESCRIPTION OF THE PREFERRED EMBODIMENTS

The present invention is credit card studded with gems to identify the card holder as an individual having top financial privileges provided by the card issuer and institutions honoring the card. For the purposes of this document the following terms of usage are defined as follows:

“Gem” refers to a natural or a synthetic mineral or other material that has sufficient beauty and durability for use as a personal adornment. This includes glass cut to look like a diamond.

“Precious stones” include diamonds, emeralds, rubies, and sapphires.

“Semi precious stones” include zircon and topaz.

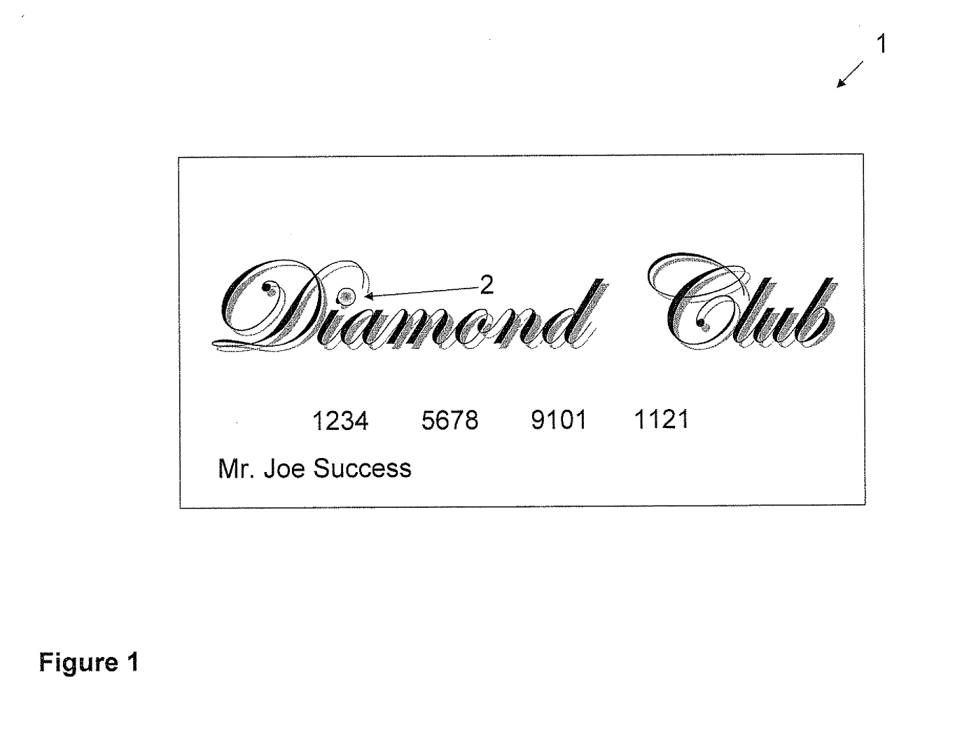

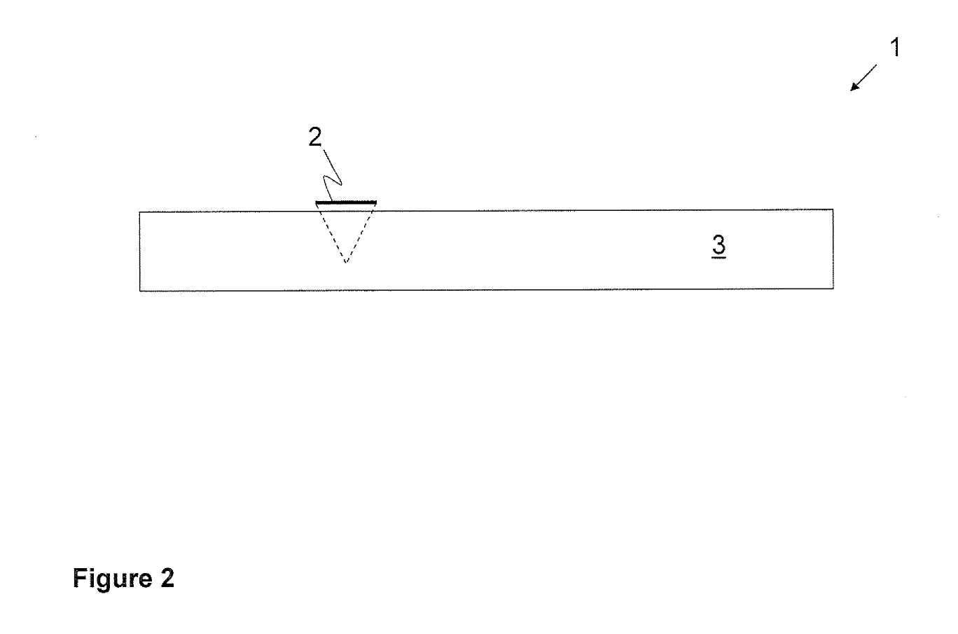

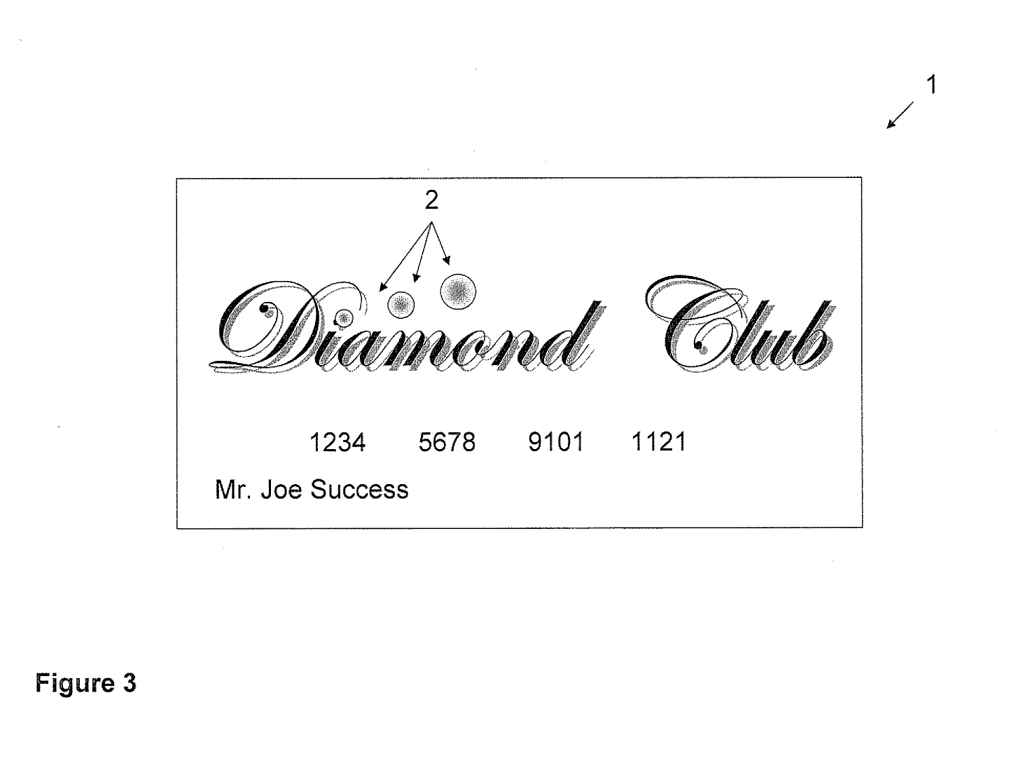

The current invention employs genuine, or imitation, precious and/or semi-precious stones interconnected to a credit card as a means of identifying the card holder as individual having top financial privileges available from the card issuer and/or the institutions honoring the card. FIGS. 1 and 2 depict credit card 1 having a diamond 2 partially imbedded in card body 3 thereby securing the stone firmly into the card body while displaying the luster of the top potion. The gem 1 is secured by way of glue or by way of heat fusion of the plastic card body 3 to gem 1. FIG. 3 depicts the credit card 1 having a plurality of embedded stones 2 by way of a non-limiting example.

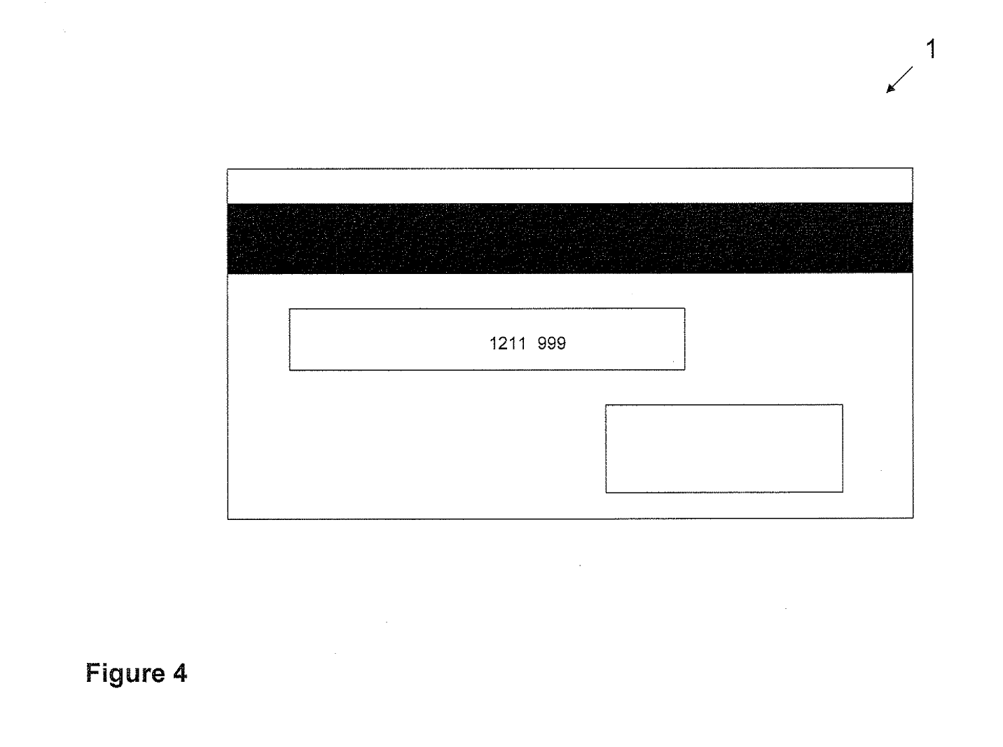

FIG. 4 depicts the reverse side of the credit card appearing in FIGS. 1 and 3. It should be noted that in a preferred embodiment, the precious stones are embedded at a depth sufficient to secure in the card body while ensuring that the bottom extremity does not protrude form the back side of the card.

It will be appreciated that the above descriptions are intended only to serve as examples, and that many other embodiments are possible within the scope of the present invention as defined in the appended claims.

What is claimed is:

1. A credit card comprising:
(a) a card body and
(b) at least one gem interconnected to said card body so as to clearly differentiate said card from other credit cards.

2. The credit card of claim 1, wherein said gem is implemented as a precious stone.

3. The credit card of claim 2, wherein said precious stone is partially imbedded in said card body.

4. The credit card of claim 3, wherein said precious stone is implemented as a natural diamond.

5. The credit card of claim 3, wherein said diamond is implemented as a synthetic diamond.

6. The credit card of claim 1, wherein said gem is implemented as an imitation diamond.

7. The credit card of claim 6, wherein said imitation diamond is imbedded in said card body.

8. The credit card of claim 1, wherein said gem is implemented as a semi-precious stone.

9. The credit card of claim 1, wherein said gem is partially embedded in said card body.

10. The credit card of claim 1, wherein said gem is implemented as a black diamond.
